(19) United States
(12) Patent Application Publication
(10) Pub. No.: US 2020/0396321 A1
(43) Pub. Date: Dec. 17, 2020

(54) A USER ADJUSTABLE ADAPTOR FOR COUPLING A SMARTPHONE TO AN ADD-ON DEVICE

(71) Applicant: Varun Akur VENKATESAN, Bangalore (IN)

(72) Inventors: Varun Akur VENKATESAN, Bangalore (IN); Gautam SHARMA, Bangalore (IN); Sushanth Konda Ananda RAO, Bangalore (IN); Aayush RAI, Bangalore (IN)

(21) Appl. No.: 16/957,183

(22) PCT Filed: Dec. 24, 2018
(86) PCT No.: PCT/IN2018/050870

§ 371 Date: Jun. 23, 2020

(30) Foreign Application Priority Data
Dec. 25, 2017 (IN) 201741026458

(51) Int. Cl. H04M 1/02; H04M 1/21; G06F 1/16; F16M 11/04

(52) U.S. Cl. CPC H04M 1/0264; F16M 11/041; G06F 1/1686; H04M 1/21

(57) ABSTRACT

The invention relates to an adaptor for coupling an add-on device to an electronic device. The adaptor consists of first gripper (101), second gripper (104) and coupler (102). The adaptor is configured to hold the electronic device (114) between the first and second gripper which are adjustable to accommodate different sized electronic devices. The coupler (102) is locked to the adapter and the coupler is configured to slide on members/rods of the adaptor to enable fixing of the add-on device at a working position with respect to the electronic device (114).

### FIELD OF THE INVENTION

The present invention relates to an adapter. More particularly the invention relates to an adapter configured for coupling an add-on device to an electronic device.

### BACKGROUND

With increasing capabilities of smart phones, gadgets that provide unique functionality in conjunction with the smart phone features have been on the rise. A few of these are lenses, projectors, speakers, scanners, microscopes and sperm counters.

Many of these applications require devices to be coupled at specific locations with respect to the phone. For example, a zoom lens is a device that can be coupled to the camera of the phone. A photographer would need to position the zoom lens in front of the camera of the phone to obtain zoomed photographs. In order to position it accurately, an adaptor is required so that once positioned correctly, the zoom lens does not change with respect to the camera. This will allow the user to move the phone and the zoom lens assembly and continue taking photos while achieving desired zoom. There are several adjustable adaptors in the market. The problem with the available adaptors is that any single one is not capable of beings used with all sizes and thickness of phones. These different models of smartphones have different positions of camera on the phone.

Adjusting the position of smartphone and add-on device every time is a hassle and offers decreased user experience. It will be desirable to adjust the position once and lock the position such that it provides an exact fit. Further, to continue enabling portability, if the adaptor is in small form, it is desirable.

Phone specific adaptors are available in the state of art. These prior arts, while offering good stability and ease of use, also have a disadvantage that they cannot be used when the phone already has a casing, or the phone is damaged. Further, the need to create multiple geometries for multiple phone widths, heights and thickness will lead to overheads in supply chain, design and manufacturing.

A few prior arts describe locking mechanisms that help the user to adjust the location of the device with respect to the camera. When the phone is removed from the adaptor and placed back, the camera assumes the same positioning. However, these locking mechanisms pose specific disadvantages. One example describes a bulky mechanism that offers sliders to position the camera with respect to the device. Here, positioning must be performed in 3 steps which include positioning the camera in X and Y locations and locking the device into position. However, this mechanism offers low stability of positioning and low stability against disturbances. This is owing to the gripping mechanism that does not hold the camera in position with adequate force. It uses soft foam like material to hold the phone and this reduces positional stability.

In view of foregoing, there is a need for an adapter which overcomes the shortcomings associated with the prior arts.

### SUMMARY OF THE INVENTION

Accordingly, the present invention provides an adaptor for coupling an add-on device to an electronic device in accordance with an embodiment of the present invention. The adaptor comprises a frame configured for accommodating a pair of grippers parallel to each other, a coupler and a pair of clamping means integrated to the coupler. The grippers are configured for slotting an electronic device. The coupler pivotably engages with the frame through a hinge and spring mechanism and slides to adjust its position. The clamping means is configured to accommodate the add on device. The coupler is slid and adjusted to be fixed at a position to clamp the add-on device in a working position with respect to an element of the electronic device.

In an embodiment, the frame includes a pair of parallel members and at least one cross member connecting the parallel members to each other. The frame includes a first end and a second end.

In an embodiment, the pair of grippers include a first gripper accommodated on a first pivotable protrusion of the first end and a second gripper accommodated on a second pivotable protrusion of the second end.

In an embodiment, the coupler is configured to slide over the pair of parallel members and the grippers are positioned on a first pair of parallel members.

In an embodiment, the coupler is pivotably connected to a first member of a first pair of parallel members, wherein the coupler is configured to slide on a second pair of parallel members.

In an embodiment, the coupler includes a locking mechanism on the second pair of parallel members configured for locking the coupler to a second member of the first pair of parallel members thereby fixing the coupler to the frame.

In an embodiment, each gripper comprises a biasing means each to adjust the grippers for accommodating the electronic device.

In an embodiment, a distance between the pair of grippers is adjustable according to width of the electronic device while simultaneously sliding.

In an embodiment, the present invention provides an adaptor for coupling an add-in device to an electronic device. The adaptor includes one or more grippers configured to slot an electronic device, a coupler movable with respect to the grippers configured to accommodate an add on device, a locking mechanism that locks the position of the add on device with respect to an element of the electronic device, wherein the position of the add on device with respect to an element of the electronic device remains the same when the adaptor is reslotted to the electronic device.

In a related embodiment, the locking mechanism simultaneously locks the relative positions of the grippers and the position of the coupler.

In an embodiment, the gripper includes a top face to prevent the electronic device from dislodging, a biasing face which contacts another face of the electronic device and provides a biasing force to hold the electronic device in place.

In an embodiment, the grippers includes a top face to prevent the electronic device from dislodging, a biasing face which contacts another face of the electronic device and provides a biasing force to hold the electronic device in place, wherein adjusting the distance between the grippers would allow slotting of electronic devices of different width and height.

In an embodiment, the grippers includes a top face to prevent the electronic device from dislodging, a biasing face which contacts another face of the electronic device, wherein a gap is formed when an electronic device is slotted, wherein the gap accommodates buttons of the electronic device and prevents actuation of the button during slotting of the adaptor.

In an advantageous aspect, the present invention provides an adapter with least complex assembly for adjusting a position of a camera in a mobile device.

Further, the adapter of the present invention gives a strong feedback to enable a user to position the camera of a mobile device correctly.

The adapter of the present invention increases stability of a camera in a mobile device during disturbances.

### BRIEF DESCRIPTION OF THE DRAWINGS

FIG. 1 shows a top view of an adaptor in accordance with an embodiment of the present invention.

FIG. 2 shows a top view of the adapter mounted on an electronic device in accordance with an embodiment of the present invention.

FIG. 3 shows a perspective view of the adapter with a top surface, a bottom surface, and a biasing surface in accordance with an embodiment of the present invention.

FIGS. 4a, 4b, 4c and 4d show different phone models as examples of how the adaptor allows for clasping different phone geometries without hindering a usage of a phone keypad in accordance with an embodiment of the present invention.

FIG. 5a shows a front view of the adapter in accordance with an embodiment of the present invention.

FIG. 5b shows a side view of the adaptor in accordance with an embodiment of the present invention.

FIG. 6a shows a front view of the adapter with a locking mechanism in accordance with an embodiment of the present invention.

FIG. 6b shows a side view of the adapter with a locking mechanism in accordance with an embodiment of the present invention.

FIG. 7 shows an adapter with biasing means according to one embodiment of the present invention.

FIG. 8 shows an adapter using a rubber band connecting additional parallel members in accordance with an embodiment of the present invention.

FIG. 9(a) shows a front view of a phone as the electronic device with an adapter in accordance with an embodiment of the present invention.

FIG. 9(b) shows a side view of the phone with the adaptor in accordance with an embodiment of the present invention.

FIG. 9(c) shows a rear view of the phone with the adaptor in accordance with an embodiment of the present invention.

FIG. 10 shows additional structures on the coupler and the grippers in accordance with an embodiment of the present invention.

### DETAILED DESCRIPTION OF THE INVENTION

Various embodiments of the present invention provide an adapter for coupling an add-on device to an electronic device for dispensing a product. The following description provides specific details of certain embodiments of the invention illustrated in the drawings to provide a thorough understanding of those embodiments. It should be recognized, however, that the present invention can be reflected in additional embodiments and the invention may be practiced without some of the details in the following description.

The various embodiments including the example embodiments will now be described more fully with reference to the accompanying drawings, in which the various embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,” “connected to,” or “coupled to” another element, it can be directly on, connected to, or coupled to the other element or intervening elements or layers that may be present. As used herein, the term “and/or” includes any and all combinations of one or more of the associated listed items.

Spatially relative terms, such as “top,” “bottom,” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures.

Embodiments described herein will refer to plan views and/or cross-sectional views by way of ideal schematic views. Accordingly, the views may be modified depending on simplistic assembling or manufacturing technologies and/or tolerances. Therefore, example embodiments are not limited to those shown in the views but include modifications in configurations formed on basis of assembling process. Therefore, regions exemplified in the figures have schematic properties and shapes of regions shown in the figures exemplify specific shapes or regions of elements, and do not limit the various embodiments including the example embodiments.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, the various embodiments including the example embodiments relate to adapter.

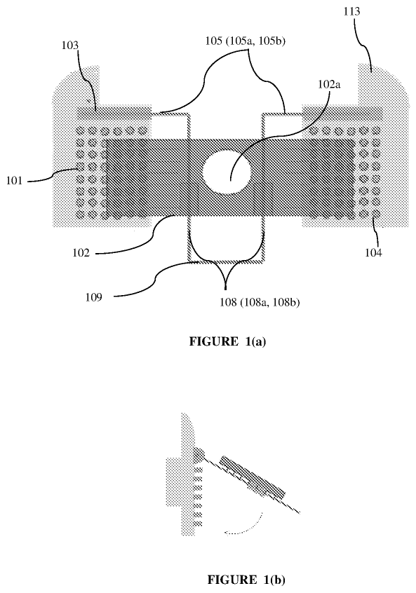

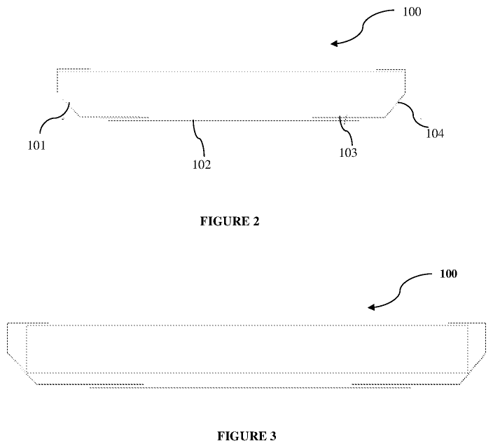

Referring to FIG. 1 and FIG. 2, an adaptor (100) is provided in accordance with an embodiment of the present invention. The perspective view (200) of the adapter (100) configured to couple an add-on device to an electronic device (114) is shown in FIG. 2. The adapter (100) consists of a frame housing a pair of grippers (101, 104) including a first gripper (101) and a second gripper (104), and a coupler (102). The coupler (102) is integrated with a clamping means for clamping the add-on device to the adapter (100). The coupler (102) has a mounting feature that allow devices to be mounted on it. For a wider phone (114), the distance between the grippers (101, 104) in increased by pulling them in opposite direction, while simultaneously sliding them over the phone (114).

Further, referring to FIG. 3, a perspective view (300) of the adapter is shown with a top surface (118) that stops the phone from moving out of the adaptor, a bottom surface (115), and a biasing surface (116) which biases the phone towards the top surface (118). The biasing surface maybe a diagonal surface or a curved surface with the intent making a contact to the phone's surfaces. One or more of said surfaces could be coated or attached with a soft material to provide a good haptic experience or to avoid damage to the phone. An additional surface (117) may be used such as a vertical surface to help with providing a smaller footprint or aesthetic value. The additional surface (117) may be used to provide additional clearance to prevent the buttons of the phone from actuation when sliding the adaptor onto the phone. While the description of the sections is only indicative, the principle can extend to curves or other geometries.

In an exemplary embodiment, the locking features of the grippers (101, 104) and the coupler (102) are such that they are complimentary to each other. The locking features fit into the protrusion (119) and depressions (120) of each other providing firm gripping of the coupler (102) and the grippers (101, 104).

FIGS. 4a, 4b, 4c and 4d show different phone model (400a, 400b, 400c, 400d) as examples of how the adaptor allows for clasping different phone geometries without hindering a usage of a phone keypad. The different phone models of different geometries with the grippers contacting the phones at different positions on the gripper surfaces is shown.

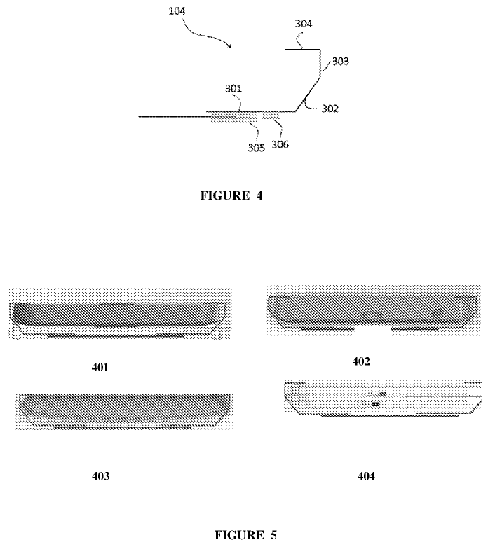

Referring to FIGS. 5a and 5b, a front view (500a) and a side view (500b) of the adapter (100) are shown in accordance with an embodiment of the present invention. The frame (113) includes a pair of parallel members 108 (108a, 108b) and at least one cross member (109) connecting the parallel members (108) to each other. The frame includes a first end (110a) and a second end (110b). The pair of grippers include a first gripper (101) accommodated on a first pivotable protrusion (105a) of the first end (110a) and a second gripper (104) accommodated on a second pivotable protrusion (105b) of the second end (110b). Further, the coupler (102) is configured to slide over the pair of parallel members (108) to change XY position.

In an exemplary embodiment the parallel members (108) or the cross member (109) are rods.

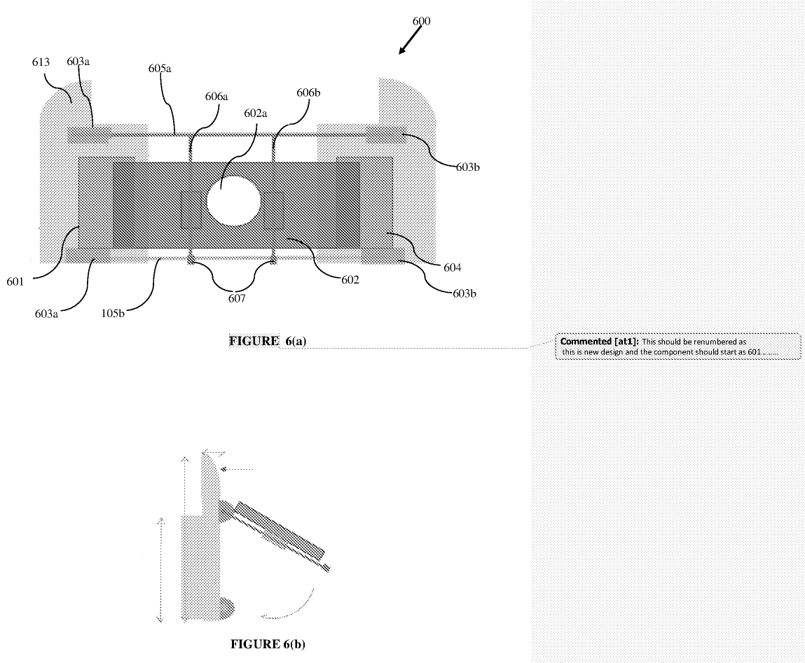

Referring to FIGS. 6a and 6b, a front view (600a) and a side view (600b) of the adapter (100) with a locking mechanism (112) is shown in accordance with an embodiment of the present invention. The grippers (101, 104) are positioned on a first pair of parallel members (107). The coupler (102) is pivotably connected to a first member (107a) of the first pair of parallel members (107), where the coupler (102) is configured to slide on a second pair of parallel members 111 (111a, 111b).

In a related embodiment, the coupler (102) further includes the locking mechanism (112) on the second pair of parallel members (111) configured for locking the coupler (102) to the second member (107b) of the first pair of parallel members (107) thereby fixing the coupler (102) to the frame.

Further, each gripper (101, 104) connected to at least one biasing means each to adjust the grippers (101, 104) for accommodating the electronic device (114).

The members of the adapter (100) are mounted on a commonly used hinge and spring mechanism such that when the user turns the hinge and snaps, the entire assembly becomes a fixed and rigid structure. The first member (107a) and the second member (107b) increases the rigidity of the adapter maintaining a small form of the adapter and also locks the coupler (102) in a fixed position.

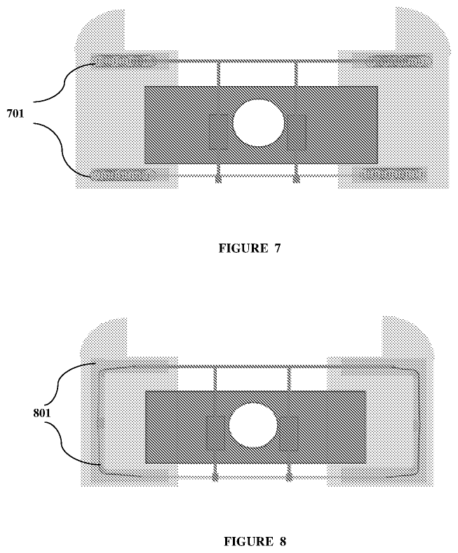

FIG. 7 shows a front view (700) of the adapter with springs (121) as part of the biasing means that cause the biasing force and allow tension when the adaptor is applied to the phone.

FIG. 8 shows a front view (800) of the adapter in another embodiment that uses a rubber band (122) as the biasing means connecting the top and bottom horizontal rods. The spring or rubber band passes through a protected channel to avoid interference from external world.

Referring to FIGS. 9a, 9b and 9c, different views (900a, 900b, 900c) of the adapter (100) mounted on the electronic device (114) is shown. The electronic device (114) is a phone with the element as the camera of the phone. The add-on device is clamped to the coupler (102) of the adapter (100) using clamping means (123) such that the camera is in-line with the add-on device. The coupler includes an opening (102a) at center such that the opening (102a) and the element of the electronic device have their central axis inline to enable the element and the add-on device to be in the working position.

In an embodiment, the electronic device (114) is a phone, a tablet, a laptop, or a user interactive computing device.

In an exemplary embodiment, for a curved phone, the ends are clasped by the gripper's vertical and upper-horizontal sections. For a flat phone, the phone is clasped by the gripper's diagonal and upper-horizontal section. While the description of the sections is only indicative, the principle can extend to curves or other geometries. In this manner, the adaptor can be slid onto with phones of different thickness and curvature.

In an embodiment, the add-on device is a lens, a plug and play probe, a blood analyzer or a plurality of plug and play electronic devices.

In an embodiment, the present invention includes a fixing means like an adhesive means applied on the adapter to maintain a fixed position of the adapter during mounting and dismounting of the adapter from the electronic device (114).

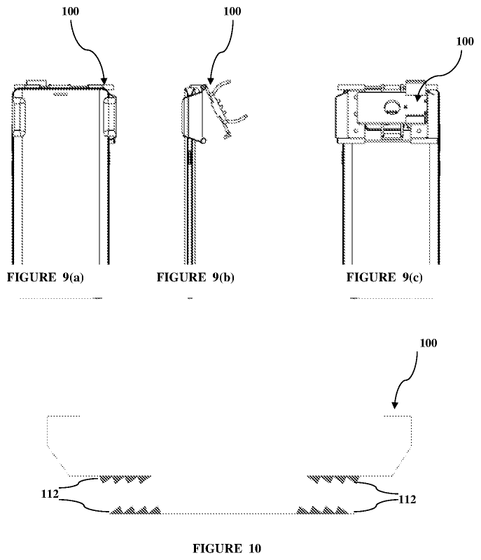

Referring to FIG. 10 a perspective view (1000) of structures (124) on the coupler and the grippers are shown so that when the coupler is locked, the structures provide additional traction and higher rigidity. Further, the structures are aligned such that when the coupler locks, it adds a force to bring the grippers together by a small distance and increases the gripping feel on the phone. This provides better user experience when sliding the adaptor on to the phone. The structural features on the grippers and coupler increases the gripping feel on the phone.

In an exemplary embodiment, the present invention uses a single step operation to mount the adaptor (100) on to the electronic device (114), during which, an adjustable mechanism changes the geometry automatically to allow the electronic device (114) to be slot into the adaptor (100). The angular elevation prior to gripping pushes the phone to the appropriate slot of the adaptor (100).

Initially, the adaptor (100) is slid on to the phone (114). The coupler (102) is positioned such that the center of the adaptor is concentric to the center of the phone camera. The coupler (102) is then locked to the body of the adaptor (100) using the members (107, 109) and the hinge and spring mechanism such that when the user turns the hinge and snaps, the entire assembly becomes a fixed and rigid structure. The position of locking is fixed to achieve alignment with a said reference point on the phone. Once positioned, the adaptor (100) is slid out of the phone and back in whenever required. The positioning of the coupler (102) and consequently, the relative positioning of the device and the phone's camera remain undisturbed.

In an exemplary embodiment, the angle through which the adaptor (100) is to be raised before being fit to the phone is an essential feature the invention.

In an embodiment, the present invention provides an adaptor (100) with two grippers whose positions are adjustable to hold a phone between them. The adaptor has the coupler that can be positioned by the user relative to the target area of the phone. The coupler possesses mounting features to mount an add-on device or gadget onto the coupler. The coupler additionally possesses locking features that lock the position of the coupler onto the grippers. The locking mechanism between the coupler and the gripper can be done by adhesive tapes, fasteners, Velcro strips or similar material or mechanisms.

The adaptor has adjustable mechanisms that change its geometry to fit a range of phone sizes. During a first use, the user adjusts the adaptor to fit the phone geometry and positions the coupler at a desirable location with respect to the phone. The adaptor has mechanisms to lock the adjustment mechanism and the position of the coupler to fix the same. For subsequent usage of the adaptor, the user only needs to slide the adaptor to the phone and the adaptor fits the phone and the coupler is located at the position that it was locked into. In this manner, the adaptor need not be adjusted for repeated usage with the same or similar phone but is also not restricted to be adapted to other phone sizes.

In an embodiment, a geometry of the adaptor includes three major portions, namely, the first gripper, the second gripper and the coupler. The first gripper and the second gripper are connected to each other by members. and they have a biasing force bringing them together or pushing them apart to make it easier for the user to apply the adaptor on to the phone. For a phone of a higher width, the distance between the grippers is increased by stretching them, while simultaneously sliding over the phone, a functionality that enhances ease of use.

Further, the grippers possess surfaces that allow contact the phone at different positions for different phone widths and thicknesses. The grippers may also possess rubber, silicone, foam or such deformable coatings or layers to prevent any damage to the phone. The gripper surfaces are so designed that they avoid actuating one or more phone buttons when the adaptor is slid to the phone.

In an exemplary embodiment, once positioned, the adaptor is slid out of the phone and back in whenever required. The positioning of the coupler and consequently, the relative positioning of the device and the phone's camera remain undisturbed even if the phone is slid out of the adaptor. The biasing force that draws the two grippers together is provided by a spring or rubber band.

After the adaptor is positioned for the first time, it can be slid out of the phone and back in whenever required. The positioning of the coupler and consequently, the relative positioning of the device and the phone's camera remain undisturbed in spite of the sliding in and out of the adaptor.

In an embodiment, during the sliding of the adaptor to the phone, portions of the coupler are distant from the camera so that it does not contact the camera in case the camera surface is raised from the phone's surface.

In an embodiment, the coupler is an aperture plate that possess an opening to couple the camera to a gadget such as an optical device. Examples of optical devices are a lens, waveguide, light source or optic fiber. The opening is made of specific geometry to restrict external light from outside the gadget reaching the phone's camera.

The connecting member is linked to the gripper via linkages. A linkage may be a hinge or a joint or it could be a spring that provides a biasing force when the distance between the grippers change. In case the connecting member is flexible, it may additionally be of a stretchable material to enable such biasing forces.

The adaptor may include a vertical stop that provides either feedback or restricts the user from sliding it further onto the phone than a prescribed length.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

I/We claim:

1. An adaptor (100) for coupling an add-on device to an electronic device, the adaptor comprises:
a frame (113) configured for accommodating a pair of grippers (101 & 104) parallel to each other, wherein the grippers are configured for slotting an electronic device;
a coupler (102) pivotably engaging with the frame and sliding in a linear direction to adjust a position of the coupler; and
a clamping means (123) integrated to the coupler (102), wherein the clamping means (123) is configured to accommodate the add on device;
wherein the coupler (102) is slid and adjusted to be fixed at a position to clamp the add-on device in a working position with respect to an element of the electronic device.

2. The adaptor as claimed in claim 1, wherein the frame includes a pair of parallel members 108 (108a, 108b) and at least one cross member (109) connecting the parallel members (108) to each other, wherein the frame includes a first end (110a) and a second end (110b).

3. The adapter as claimed in claim 2, wherein the pair of grippers include:
a first gripper (101) accommodated on a first pivotable protrusion (105a) of the first end (110a) and a second gripper (104) accommodated on a second pivotable protrusion (105b) of the second end (110b).

4. The adapter as claimed in claim 3, wherein the coupler (102) is configured to slide over the pair of parallel members (108).

5. The adapter as claimed in claim 1, wherein the grippers (101, 104) are positioned on a first pair of parallel members (107).

6. The adapter as claimed in claim 5, wherein the coupler (102) is pivotably connected to a first member (107a) of the first pair of parallel members (107), wherein the coupler (102) is configured to slide on a second pair of parallel members 111 (111a, 111b).

7. The adapter as claimed in claim 6, wherein the coupler (102) further comprises a locking mechanism (112) on the second pair of parallel members (111) configured for locking the coupler (102) to the second member (107b) of the first pair of parallel members (107) thereby fixing the coupler (102) to the frame.

8. The adapter as claimed in claim 1, wherein each gripper (101, 104) connected to at least one biasing means (121) each to adjust the grippers (101, 104) for accommodating the electronic device.

9. The adapter as claimed in claim 1, wherein a distance between the pair of grippers is adjustable according to width of the electronic device while simultaneously sliding.

10. The adapter as claimed in claim 1, wherein the electronic device includes a phone, a tablet, a laptop, and a user interactive computing device.

11. The adapter as claimed in claim 7, wherein the locking mechanism (112) comprises an adhesive means applied on the adapter (100) to maintain a fixed position of the adapter (100) during mounting and dismounting of the adapter from the electronic device.

12. The adapter as claimed in claim 1, wherein the element of the electronic device is a camera.

13. The adapter as claimed in claim 1, wherein the add-on device comprises a lens, a plug and play probe, a blood analyzer and a plurality of plug and play electronic devices.

14. The adapter as claimed in claim 1, wherein the coupler 102 includes an opening 102a at center such that the opening 102a and the element of the electronic device have their central axis inline to enable the element and the add-on device to be in the working position.

15. An adaptor (100) for coupling an add-in device to an electronic device, the adaptor comprises:
one or more grippers configured to slot an electronic device;
a coupler movable with respect to the grippers configured to accommodate an add on device;
a locking mechanism that locks the position of the add on device with respect to an element of the electronic device;
wherein the position of the add on device with respect to an element of the electronic device remains the same when the adaptor is reslotted to the electronic device.

16. An adaptor (100) as claimed in 15, wherein the locking mechanism simultaneously locks the relative positions of the grippers and the position of the coupler.

17. The adapter as claimed in claim 15, wherein the gripper (101 & 104) comprising:
a top face (118) to prevent the electronic device from dislodging;
a biasing face (116) which contacts another face of the electronic device and provides a biasing force to hold the electronic device in place

18. The adapter as claimed in claim 15, wherein the grippers (101&104) comprise:
a top face (118) to prevent the electronic device from dislodging;
a biasing face (116) which contacts another face of the electronic device and provides a biasing force to hold the electronic device in place;
wherein adjusting the distance between the grippers would allow slotting of electronic devices of different width and height.

19. The adapter as claimed in claim 15, wherein the grippers (101&104) comprise:
a top face (118) to prevent the electronic device from dislodging;
a biasing face (116) which contacts another face of the electronic device,
wherein a gap is formed when an electronic device is slotted,
wherein the gap accommodates buttons of the electronic device and prevents actuation of the button during slotting of the adaptor.
